(19) United States
(12) Patent Application Publication
(10) Pub. No.: US 2020/0369489 A1
(43) Pub. Date: Nov. 26, 2020

(54) PAPER SHEET HANDLING DEVICE

(71) Applicant: FUJITSU FRONTECH LIMITED, Tokyo (JP)

(72) Inventors: Tatsuya SHIMAMURA, Inagi (JP); Tsuyoshi ABE, Inagi (JP); Isamu ESAKI, Inagi (JP); Tetsuya ODAKA, Inagi (JP); Akihiro TANAKA, Inagi (JP); Ryoka NIIKUNI, Inagi (JP); Takashi WADA, Inagi (JP); Akira YAMADA, Inagi (JP)

(73) Assignee: FUJITSU FRONTECH LIMITED, Tokyo (JP)

(21) Appl. No.: 16/991,692

(22) Filed: Aug. 12, 2020

Related U.S. Application Data
(63) Continuation of application No. PCT/JP2018/011882, filed on Mar. 23, 2018.

(51) Int. Cl. B65H 31/24; B65H 43/00; G07D 11/18; G07D 11/13

(52) U.S. Cl. CPC B65H 31/24; B65H 43/00; G07D 11/18; G07D 7/187; B65H 2701/1912; G07D 2211/00; G07D 2207/00; G07D 11/13

(57) ABSTRACT

A conveyance mechanism can convey bills to openings in two locations regarding at least one conveyance port of two conveyance ports of a determination unit. The conveyance mechanism can convey the bills between an acceptance unit and a plurality of cassettes through the determination unit. The conveyance mechanism can convey the bills from any cassette of the plurality of cassettes to other cassettes through the determination unit.

### CROSS-REFERENCE TO RELATED APPLICATION

This application is a continuation application of International Application PCT/JP2018/011882, filed on Mar. 21, 2018, the entire contents of which are incorporated herein by reference.

### FIELD

The present invention relates to a paper sheet handling device.

### BACKGROUND

A bill handling device that handles bills such as an automated teller machine (ATM) installed in a bank and the like and a cash dispenser installed in a back office of a store and the like has been conventionally known. Such a bill handling device provided with, for example, an acceptance unit in which a conveyance path capable of conveying bills is formed in a loop shape to accept the bills along the conveyance path, a determination unit that determines types of the bills, and a plurality of storage units that stores the bills.

Patent Literature 1: International Publication No. 2016/203552

By the way, a bill handling device can ensure security of the inside when the entire case body is constituted of a thick metal plate and configured such that only limited persons can open the case body. However, in a case where a failure such as a bill conveyance failure occurs inside, only the limited persons can open the case body, and thus maintenance performance declines.

Therefore, bill handling devices having a structure in which the inside is divided into a plurality of cases so as to suppress a decline in the maintenance performance and ensure security have been increasing. For example, in a bill handling device, the inside is divided into an upper case and a lower case, an acceptance unit that accepts bills and a determination unit that determines the types of the bills are arranged in the upper case, and a cassette that stores and keeps the bills is arranged in the lower case. The lower case is enclosed with a thick metal plate and is high-order security that can be accessed by only limited persons. In this way, the bill handling device can ensure security of the inside of the lower case even when the inside of the upper case is maintained.

However, when the inside is divided into a plurality of cases, conveyance paths capable of conveying bills between the cases are limited, and thus expandability decreases.

Note that the problem described above occurs in the conventional paper sheet handling devices that handles paper sheets.

In view of the above, an object of the disclosed technique is to provide a paper sheet handling device that can ensure high expandability.

### SUMMARY

According to an aspect of an embodiment, a paper sheet handling device includes: a first case provided with an acceptance unit that accepts paper sheets and a determination unit that determines types of paper sheets that are conveyed between two conveyance ports; a second case in which paper sheets can pass from and to the first case through openings in two locations and a plurality of cassettes capable of storing paper sheets can be arranged; and a conveyance mechanism that is arranged in the first case and the second case, can convey paper sheets to the openings in two locations regarding at least one conveyance port of the two conveyance ports of the determination unit, can convey paper sheets between the acceptance unit and the plurality of cassettes through the determination unit, and can convey paper sheets from any cassette of the plurality of cassettes to other cassettes through the determination unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating an example of a configuration of a bill handling device according to an embodiment.

FIG. 2A is a view illustrating an example of a flow of bills at time of depositing.

FIG. 2B is a view illustrating an example of a flow of bills at time of depositing.

FIG. 3 is a view illustrating an example of a flow of bills at time of dispensing.

FIG. 4A is a view illustrating an example of a flow of bills at time of examination.

FIG. 4B is a view illustrating an example of a flow of bills at time of examination.

FIG. 5 is a view illustrating examples of detachable units.

FIG. 6A is a view illustrating an example of the bill handling device with a minimum configuration.

FIG. 6B is a view illustrating an example of a flow of bills at time of depositing with the minimum configuration.

FIG. 6C is a view illustrating an example of a flow of bills at time of dispensing with the minimum configuration.

FIG. 6D is a view illustrating an example of a flow of bills at time of examination with the minimum configuration.

FIG. 7 is a view illustrating an example of a configuration of the bill handling device provided with a cassette for rejection.

FIG. 8 is a view illustrating another example of a conveyance path of the bill handling device according to the embodiment.

FIG. 9 is a view illustrating another example of a conveyance path of the bill handling device according to the embodiment.

FIG. 10 is a view illustrating another example of a configuration of the bill handling device according to the embodiment.

### DESCRIPTION OF EMBODIMENTS

An embodiment of a paper sheet handling device according to the present disclosure is described below with reference to the drawings. Note that in the following embodiment, a case in which bills are exemplified as paper sheets and a bill handling device is exemplified as a paper sheet handling device will be described as an example. However, the disclosed technique is not limited thereto.

### Embodiment

<Configuration of Bill Handling Device>

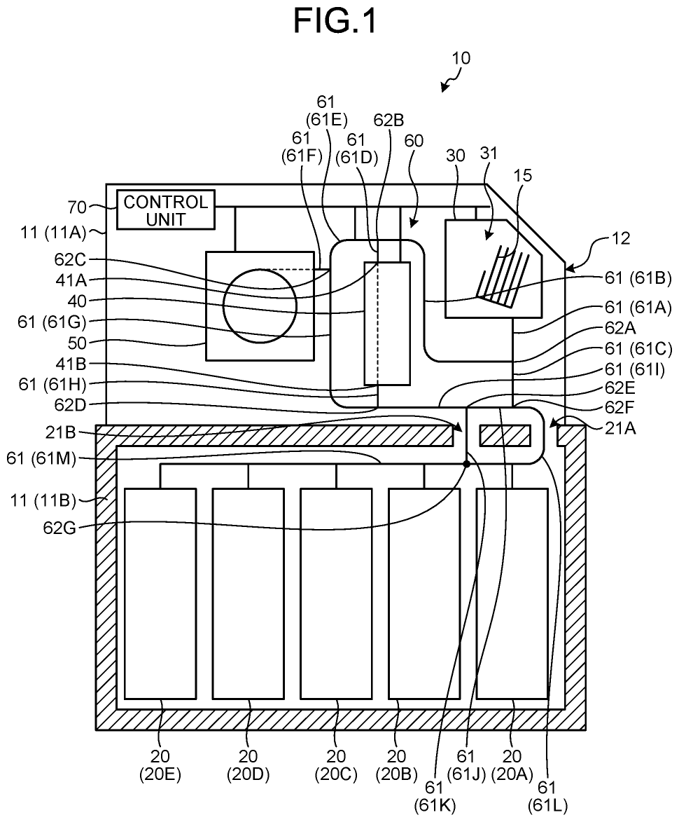

FIG. 1 is a view illustrating an example of a configuration of a bill handling device according to an embodiment. A bill handling device 10 is a device that handles bills such as an ATM and a cash dispenser.

In order to secure high expandability, various units are detachable from the bill handling device 10. The bill handling device 10 is configured to be capable of responding to various customer requests through combining of various units according to mounted functions such as bill depositing, bill dispensing, and bill examination. For example, the bill handling device 10 can be configured as an ATM or a cash dispenser through combining of various units. FIG. 1 illustrates an example of combination of units needed for basic functions related to bill handling such as bill depositing, bill dispensing, and bill examination.

The bill handling device 10 has a case body 12 that is composed of a plurality of cases 11. For example, the bill handling device 10 of the embodiment has the case body 12 composed of an upper case 11A and a lower case 11B.

The case 11B is enclosed with a thick metal plate and has a configuration like a safe box, and is a relatively high-order security area that can be accessed by only limited persons such as a manager, for example. A plurality of cassettes 20 is arranged side by side inside the case 11B. In the embodiment, five cassettes 20A to 20E are arranged side by side inside the case 11B.

The case 11B has openings 21A and 21B formed in two locations on an upper surface facing the case 11A, and bills 15 can pass between the case 11A and the case 11B through the openings 21A and 21B. In general, the security of the case 11B declines as the number of formed openings increases. In the bill handling device 10 of the embodiment, in order to suppress a decline in the security of the case 11B, the number of openings is two. The opening 21A is provided at one end of the plurality of cassettes 20 arranged side by side. In the embodiment, the opening 21A is provided above the cassette 20A which is the first from the one end. The opening 21B is provided leaving a space corresponding to a width of one to two of the cassettes 20 from the one end. In the embodiment, the opening 21B is provided above a space between the cassette 20A which is the first from the one end and the cassette 20B which is the second from the one end.

As compared with the case 11B, the case 11A is a low-order security area, and is provided with an acceptance unit 30, a determination unit 40, and a temporary holding unit 50.

By composing the case body 12 by the cases 11A and 11B as described above, the bill handling device 10 can maintain the security inside the case 11B even when a maintenance operator maintains the case 11A, for example.

The acceptance unit 30 accepts at least one of depositing and dispensing of the bills 15. For example, the acceptance unit 30 is provided with an operation panel, which is not illustrated, for accepting various operations. Moreover, the acceptance unit 30 is provided with a storage space 31 in which the bills 15 deposited and dispensed by the user is stored.

The determination unit 40 determines the types of the bills 15. For example, the determination unit 40 has two conveyance ports 41A and 41B, and is configured to allow the bills 15 to pass between the conveyance ports 41A and 41B. The determination unit 40 determines the types and authenticity of the bills 15 when the bills 15 pass between the conveyance ports 41A and 41B. For example, the determination unit 40 determines denominations of the bills 15 as types of the bills 15. Note that the determination unit 40 may determine the degree of damage or dirt of the bills 15.

The temporary holding unit 50 temporarily holds the bills 15. For example, the temporary holding unit 50 is a winding type holding unit having a band-shaped tape and a winding drum. The temporary holding unit 50 can temporarily store the bills 15 by sandwiching the bills 15 between strips of the tape when the winding drum winds the tape, and take out the stored bills 15 by rewinding the tape from the winding drum.

The bill handling device 10 is provided with a conveyance mechanism 60 that conveys the bills 15 in the upper case 11A and the lower case 11B. The conveyance mechanism 60 includes a conveyance path 61 for moving the bills 15 inside the case 11A and the case 11B and is provided with a motor, a roller, and the like, which are not illustrated, for moving the bills 15 along the conveyance path 61. The conveyance path 61 branches according to a route for moving the bills 15. Moreover, in the conveyance path 61, a switching mechanism such as a switching claw that switches a conveyance direction of the bills 15 is arranged in a branching point in which the route branches, and thus the route through which the bills 15 are conveyed can be switched. For example, a conveyance path 61A is connected with the acceptance unit 30. The conveyance path 61A is branched into a conveyance path 61B and a conveyance path 61C at a branching point 62A. The conveyance path 61B is branched into a conveyance path 61D and a conveyance path 61E at a branching point 62B. The conveyance path 61D is connected with the conveyance port 41A of the determination unit 40. The conveyance path 61E is branched into a conveyance path 61F and a conveyance path 61G at a branching point 62C. The conveyance path 61F is connected with the temporary holding unit 50. The conveyance path 61G is branched into a conveyance path 61H and a conveyance path 61I at a branching point 62D. The conveyance path 61H is connected with the conveyance port 41B of the determination unit 40. The conveyance path 61I is branched into a conveyance path 61J and a conveyance path 61K at a branching point 62E. The conveyance path 61K passes through the opening 21B. The conveyance path 61J is branched into the above-mentioned conveyance path 61C and a conveyance path 61L at a branching point 62F. The conveyance path 61L passes through the opening 21A, is arranged above the cassettes 20, and branched into the above-mentioned conveyance path 61K and a conveyance path 61M at a branching point 62G. The conveyance path 61L is provided with a branch to the first cassette 20A. The conveyance path 61M is arranged above the cassettes 20 and provided with branches to the second to fifth cassettes 20B to 20E.

In the conveyance mechanism 60, the conveyance paths 61B, 61C, 61E, 61G, 61I, and 61J form a loop. Moreover, in the conveyance mechanism 60, the conveyance paths 61J, 61L, and 61K form a loop.

Regarding at least one of the two conveyance ports 41A and 41B of the determination unit 40, the conveyance mechanism 60 can convey the bills 15 to the openings 21A and 21B in two locations. Regarding each of the conveyance ports 41A and 41B, the conveyance mechanism 60 of the embodiment can convey the bills 15 to the openings 21A and 21B in two locations. For example, by causing the bills 15 to pass through the conveyance paths 61H, 61I, and 61K, the conveyance mechanism 60 can convey the bills 15 from the conveyance port 41B to the opening 21B. Moreover, by causing the bills 15 to pass through the conveyance paths 61H, 61I, 61J, and 61L, the conveyance mechanism 60 can convey the bills 15 from the conveyance port 41B to the opening 21A. Moreover, by causing the bills 15 to pass through the conveyance paths 61D, 61B, 61C, 61J and 61K, the conveyance mechanism 60 can convey the bills 15 from the conveyance port 41A to the opening 21B. Moreover, by causing the bills 15 to pass through the conveyance paths 61D, 61B, 61C, and 61L, the conveyance mechanism 60 can convey the bills 15 from the conveyance port 41A to the opening 21A.

The conveyance mechanism 60 can convey the bills 15 between the acceptance unit 30 and the plurality of cassettes 20 through the determination unit 40. For example, by causing the bills 15 to pass through the conveyance paths 61A, 61B, 61D, 61H, 61I, 61K, and 61M, the conveyance mechanism 60 can convey the bills 15 from the acceptance unit 30 to the cassettes 20B to 20E through the determination unit 40. Moreover, by causing the bills 15 to pass through the conveyance paths 61A, 61B, 61D, 61H, 61I, 61J, and 61L, the conveyance mechanism 60 can convey the bills 15 from the acceptance unit 30 to the cassette 20A through the determination unit 40.

Moreover, the conveyance mechanism 60 can convey the bills 15 from any cassette of the plurality of cassettes 20 to the other cassettes 20 through the determination unit 40. For example, by causing the bills 15 to pass through the conveyance paths 61L, 61C, 61B, 61D, 61H, 61I, 61K, and 61M, the conveyance mechanism 60 can convey the bills 15 between the cassette 20A and the cassettes 20B to 20E through the determination unit 40.

The conveyance mechanism 60 has the conveyance paths 61A to 61M as described above to allow the bills 15 to pass through the determination unit 40 when the bills 15 are handled.

The bill handling device 10 has a control unit 70 that controls the entire device. For example, the control unit 70 is a computer, and includes a central processing unit (CPU), a random access memory (RAM), a read only memory (ROM), an auxiliary storage device, and the like. The control unit 70 is electrically connected to each of the acceptance unit 30, the determination unit 40, the temporary holding unit 50, and the conveyance mechanism 60. In the control unit 70, the CPU controls various operations such as bill depositing, bill dispensing, and bill examination through control of the acceptance unit 30, the determination unit 40, the temporary holding unit 50, and the conveyance mechanism 60 based on programs stored in the ROM or the auxiliary storage device, and various data. The control unit 70 controls the conveyance mechanism 60 so as to allow the bills 15 to pass through the determination unit 40 when the bills 15 are handled for depositing, dispensing, examination, and the like.

[Operation of Bill Handling Device]

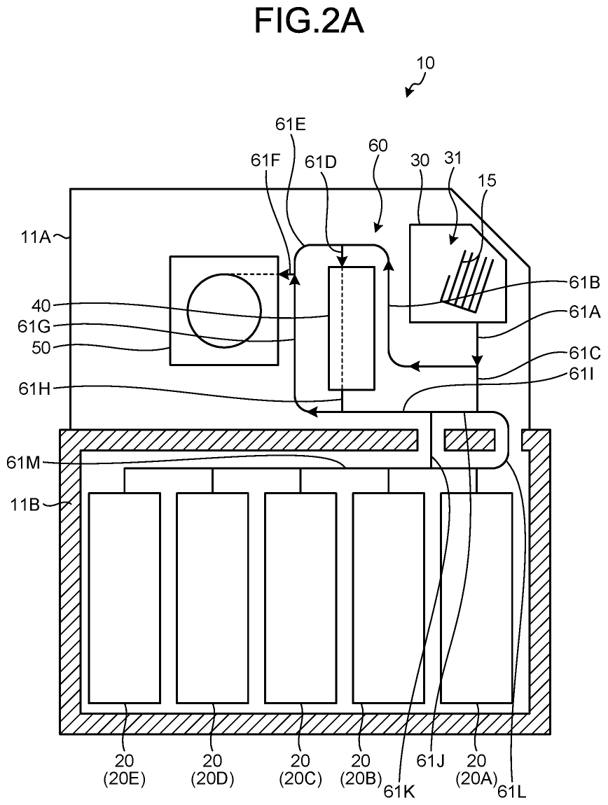

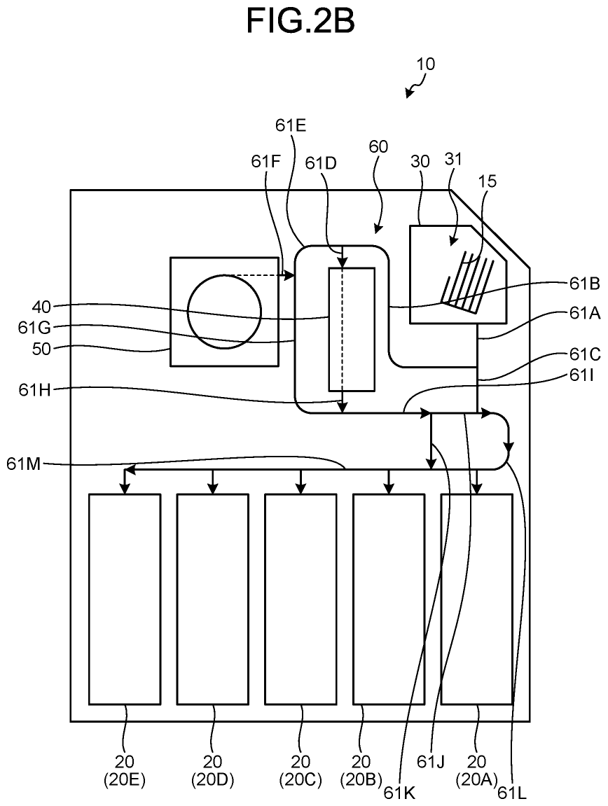

Next, operations of the bill handling device 10 configured in this way will be described. First, the operation of depositing the bills 15 will be described. Note that in each of the following drawings, illustrations of configurations of parts related to the control unit 70 will be omitted. FIGS. 2A and 2B are views each illustrating an example of a flow of bills at time of depositing. The acceptance unit 30 accepts the bills 15 from the user in the storage space 31. In the case of the depositing operation, the control unit 70 controls the conveyance mechanism 60 to take out the bills 15 stored in the storage space 31 one by one. The control unit 70 then controls the conveyance mechanism 60 to convey the bills 15 that have been taken out to the determination unit 40 through the conveyance paths 61A, 61B, and 61D, as illustrated in FIG. 2A, and the determination unit 40 determines the types of the bills 15. The control unit 70 then controls the conveyance mechanism 60 and the temporary holding unit 50 to convey the bills 15 whose types have been determined by the determination unit 40 to the temporary holding unit 50 through the conveyance paths 61H, 61G, and 61F, and temporarily holds the bills 15 in the temporary holding unit 50. The control unit 70 displays information according to the determination result by the determination unit 40 in an operation panel of the acceptance unit 30. For example, the control unit 70 displays an amount of money based on the types of the bills 15. When receiving an operation that reports that the amount of money is incorrect from the user with respect to the operation panel, or when receiving an operation of cancelling depositing, the control unit 70 conveys the bills 15 held in the temporary holding unit 50 to the storage space 31 of the acceptance unit 30 by following the route opposite to the route at time of depositing.

On the other hand, when receiving an operation that reports that the amount of money is correct from the user with respect to the operation panel, the control unit 70 controls the conveyance mechanism 60 and the temporary holding unit 50 to take out the bills 15 temporarily held in the temporary holding unit 50, as illustrated in FIG. 2B. The control unit 70 then controls the conveyance mechanism 60 to convey the bills 15 that have been taken out to the determination unit 40 through the conveyance paths 61F, 61E, and 61D, and the determination unit 40 determines the types of the bills 15 again. The control unit 70 then controls the conveyance mechanism 60 to store the bills 15 whose types have been determined by the determination unit 40 in the cassettes 20 for each type. For example, the control unit 70 stores the bills 15 in separate cassettes 20 for each denomination such as 10,000 bill, 5,000 bill, and 1,000 bill. Note that the control unit 70 may store the same type of bills 15 in the plurality of cassettes 20 separately.

The control unit 70 controls the conveyance mechanism 60 to convey the bills 15 whose types have been determined by the determination unit 40 to the cassettes 20B to 20E through the conveyance paths 61H, 61I, 61K, and 61M. Moreover, the control unit 70 controls the conveyance mechanism 60 to convey the bills 15 whose types have been determined by the determination unit 40 to the cassette 20A through the conveyance paths 61H, 61I, 61J, and 61L. Note that the control unit 70 may control the conveyance mechanism 60 to convey the bills 15 whose types have been determined by the determination unit 40 to the cassettes 20B to 20E through the conveyance paths 61H, 61I, 61J, 61L, and 61M.

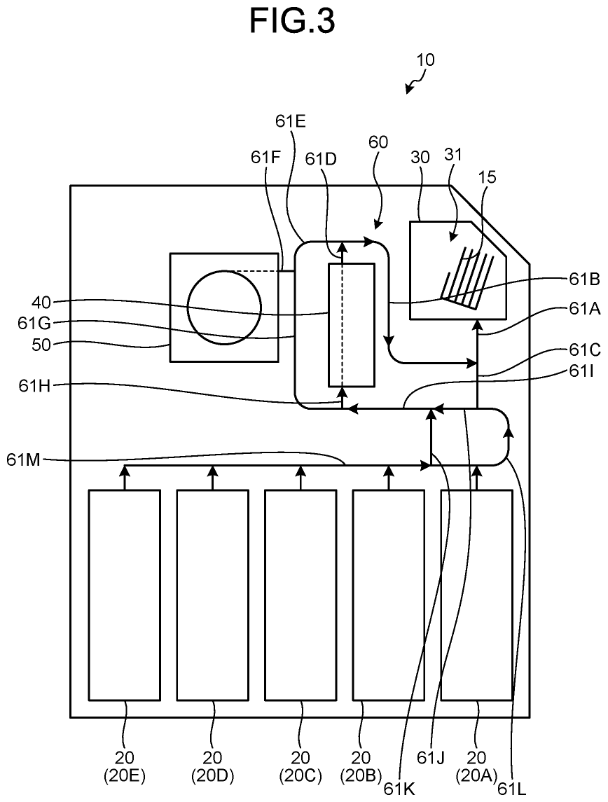

Next, the operation of dispensing of the bills 15 will be described. FIG. 3 is a view illustrating an example of a flow of bills at time of dispensing. When receiving the operation of dispensing from the user with respect to the operation panel, the control unit 70 specifies a combination of the bills 15 that becomes the specified amount of money. When the specified bills 15 are stored in the cassettes 20B to 20E, the control unit 70 controls the conveyance mechanism 60 to take out the bills 15 one by one from the cassettes 20B to 20E. The control unit 70 then controls the conveyance mechanism 60 to convey the bills 15 that have been taken out to the determination unit 40 through the conveyance paths 61M, 61K, 61I, and 61H and the determination unit 40 determines the types of the bills 15. Moreover, when the specified bills 15 are stored in the cassette 20A, the control unit 70 controls the conveyance mechanism 60 to take out the bills 15 one by one from the cassette 20A. The control unit 70 then controls the conveyance mechanism 60 to convey the bills 15 that have been taken out to the determination unit 40 through the conveyance paths 61L, 61J, 61I, and 61H and the determination unit 40 determines the types of the bills 15. Note that the control unit 70 may convey the bills 15 that have been stored in the cassettes 20B to 20E to the determination unit 40 through the conveyance paths 61M, 61L, 61J, 61I, and 61H.

The control unit 70 then controls the conveyance mechanism 60 to convey the bills 15 whose types have been determined by the determination unit 40 to the storage space 31 of the acceptance unit 30 through the conveyance paths 61D, 61B, and 61A.

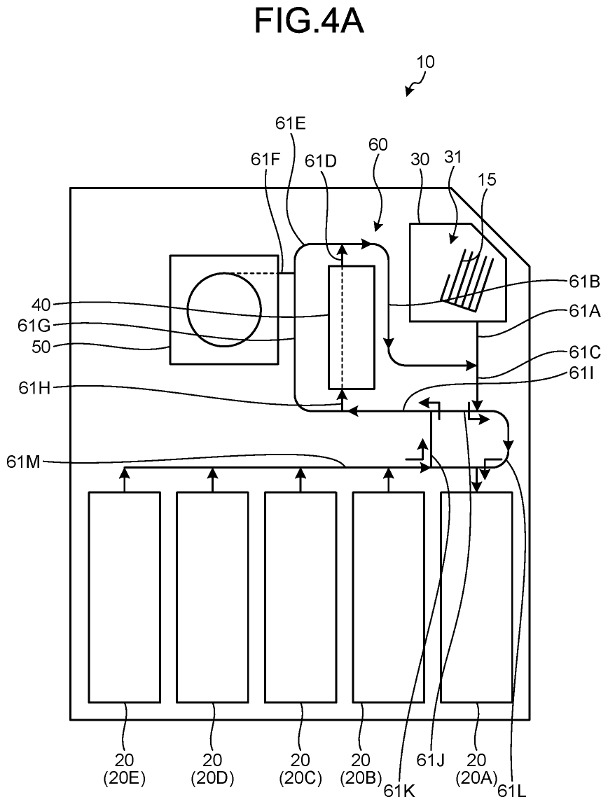

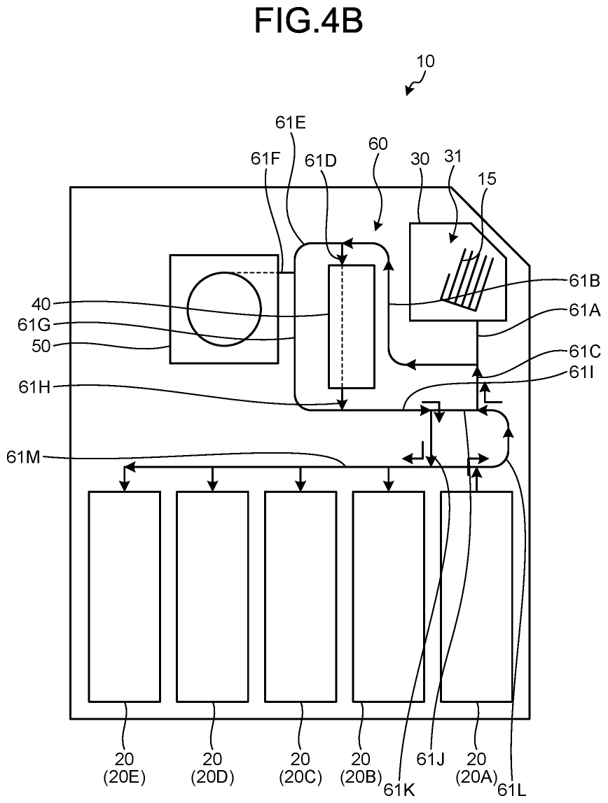

Next, the operation of examination of the bills 15 will be described. FIGS. 4A and 4B are views each illustrating an example of a flow of bills at time of examination. The bill handling device 10 examines the bills 15 while moving the bills 15 among the cassettes 20. In order to store the examined bills 15, the bill handling device 10 empties any one of the cassettes 20. For example, the bill handling device 10 empties the cassette 20A. The cassette 20A may be empty in advance. Alternatively, the bill handling device 10 may empty the cassettes 20A by moving the bills 15 stored in the cassette 20A to the cassettes 20B to 20E.

When examining the bills 15 stored in the cassettes 20B to 20E, the control unit 70 controls the conveyance mechanism 60 to take out the bills 15 one by one from the cassettes 20B to 20E, as illustrated in FIG. 4A. The control unit 70 then controls the conveyance mechanism 60 to convey the bills 15 that have been taken out to the determination unit 40 through the conveyance paths 61M, 61K, 61I, and 61H and the determination unit 40 determines the types of the bills 15. The control unit 70 then controls the conveyance mechanism 60 to convey the bills 15 whose types have been determined by the determination unit 40 to the cassette 20A through the conveyance paths 61D, 61B, 61C, and 61L.

On the other hand, when examining the bills 15 stored in the cassette 20A, the control unit 70 controls the conveyance mechanism 60 to take out the bills 15 one by one from the cassette 20A, as illustrated in FIG. 4B. The control unit 70 then controls the conveyance mechanism 60 to convey the bills 15 that have been taken out to the determination unit 40 through the conveyance paths 61L, 61C, 61B, and 61D and the determination unit 40 determines the types of the bills 15. The control unit 70 then controls the conveyance mechanism 60 to convey the bills 15 whose types have been determined by the determination unit 40 to the cassettes 20B to 20E through the conveyance paths 61H, 61I, 61K, and 61M.

In this way, the bill handling device 10 according to the embodiment can includes basic functions related to bill handling such as bill depositing, bill dispensing, and bill examination.

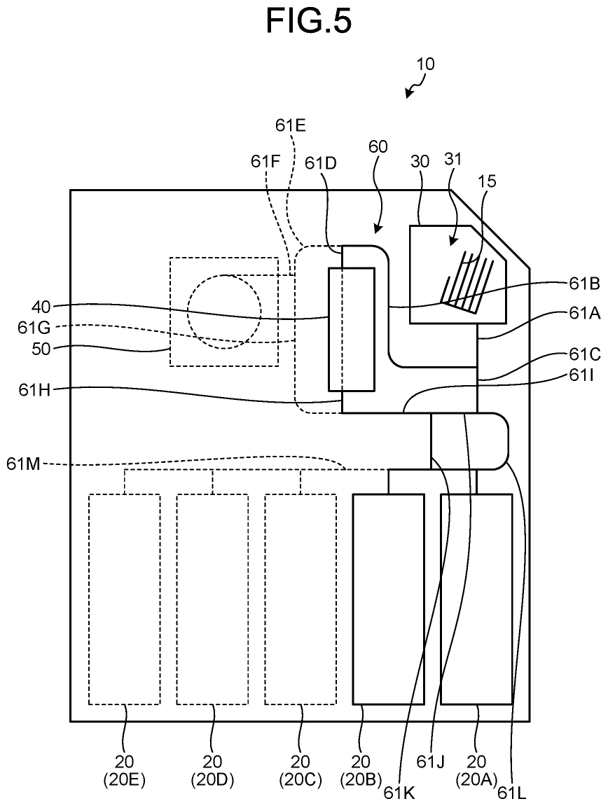

Moreover, as described above, in order to secure high expandability, various units are detachable from the bill handling device 10. FIG. 5 is a view illustrating examples of detachable units. In FIG. 5, detachable units are indicated with broken lines. For example, in the bill handling device 10, the temporary holding unit 50, the cassettes 20, and a part of the conveyance mechanism 60 are detachable. In this way, the bill handling device 10 according to the embodiment ensures high expansibility.

In FIG. 5, units needed for a minimum configuration are indicated with solid lines. The bill handling device 10 can be configured by the acceptance unit 30, the determination unit 40, two of the cassettes 20 (20A and 20B), and the conveyance mechanism 60 as a minimum configuration.

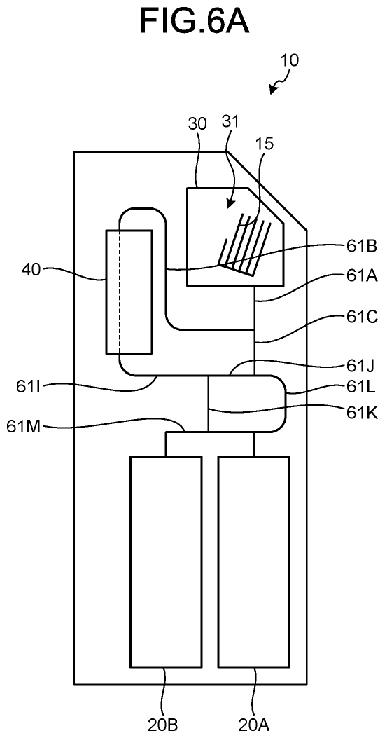

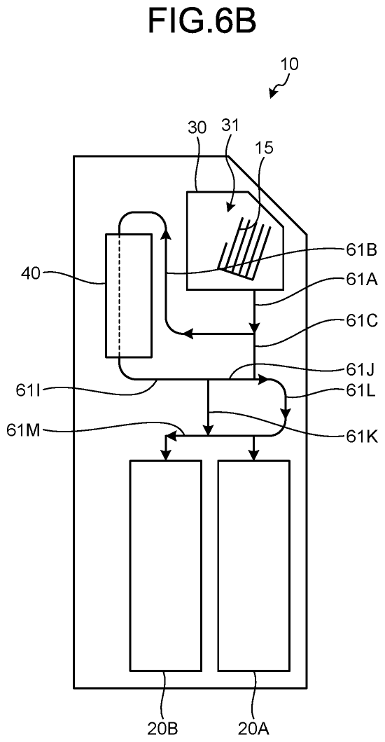

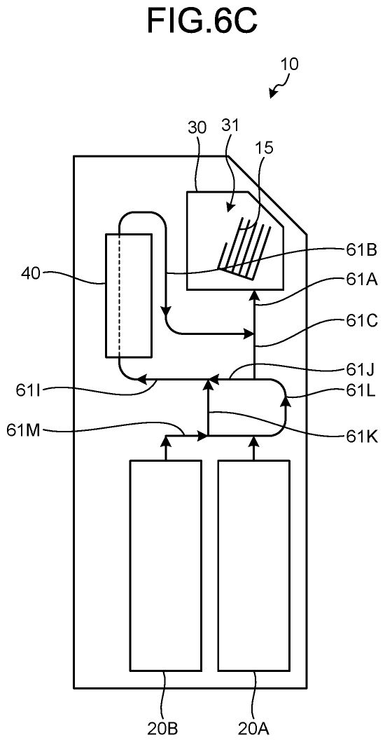

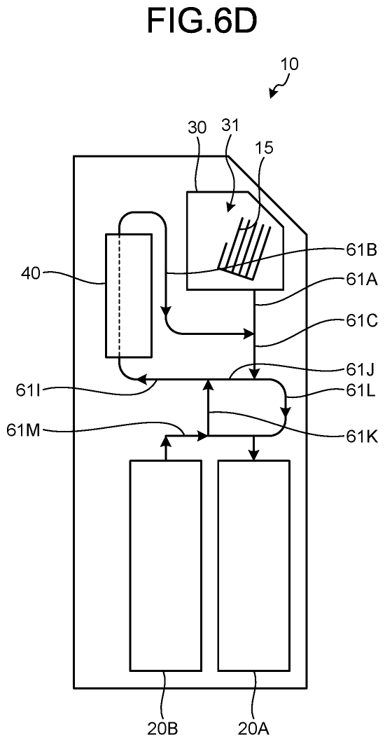

FIG. 6A is a view illustrating an example of the bill handling device with a minimum configuration. The bill handling device 10 can be configured by the acceptance unit 30, the determination unit 40, two of the cassettes 20 (20A and 20B), and the conveyance mechanism 60 as a minimum configuration. In the conveyance mechanism 60 of the minimum configuration, the conveyance path 61B is connected with the conveyance port 41A of the determination unit 40 and the conveyance path 61I is connected with the conveyance port 41B of the determination unit 40. The bill handling device 10 can realize bill depositing, bill dispensing, and bill examination even with the minimum configuration.

FIG. 6B is a view illustrating an example of a flow of bills at time of depositing with the minimum configuration. The control unit 70 controls the conveyance mechanism 60 to take out the bills 15 stored in the storage space 31 one by one. The control unit 70 then controls the conveyance mechanism 60 to convey the bills 15 that have been taken out to the determination unit 40 through the conveyance paths 61A and 61B and the determination unit 40 determines the types of the bills 15. The control unit 70 then controls the conveyance mechanism 60 to convey the bills 15 whose types have been determined by the determination unit 40 to the cassette 20B through the conveyance paths 61I, 61K, and 61M. Moreover, the control unit 70 controls the conveyance mechanism 60 to convey the bills 15 whose types have been determined by the determination unit 40 to the cassette 20A through the conveyance paths 61I, 61J, and 61L. Note that the control unit 70 may control the conveyance mechanism 60 to convey the bills 15 whose types have been determined by the determination unit 40 to the cassette 20B through the conveyance paths 61I, 61J, 61L, and 61M.

FIG. 6C is a view illustrating an example of a flow of bills at time of dispensing with the minimum configuration. When receiving the operation of dispensing from the user with respect to the operation panel, the control unit 70 specifies a combination of the bills 15 that becomes the specified amount of money. When the specified bills 15 are stored in the cassette 20B, the control unit 70 controls the conveyance mechanism 60 to take out the bills 15 one by one from the cassette 20B. The control unit 70 then controls the conveyance mechanism 60 to convey the bills 15 that have been taken out to the determination unit 40 through the conveyance paths 61M, 61K, and 61I and the determination unit 40 determines the types of the bills 15. Moreover, when the specified bills 15 are stored in the cassette 20A, the control unit 70 controls the conveyance mechanism 60 to take out the bills 15 one by one from the cassette 20A. The control unit 70 then controls the conveyance mechanism 60 to convey the bills 15 that have been taken out to the determination unit 40 through the conveyance paths 61L, 61J, and 61I and the determination unit 40 determines the types of the bills 15. Note that the control unit 70 may also convey the bills 15 that have been stored in the cassette 20B to the determination unit 40 through the conveyance paths 61M, 61L, 61J, and 61I.

The control unit 70 then controls the conveyance mechanism 60 to convey the bills 15 whose types have been determined by the determination unit 40 to the storage space 31 of the acceptance unit 30 through the conveyance paths 61D, 61B, and 61A.

FIG. 6D is a view illustrating an example of a flow of bills at time of examination with the minimum configuration. The bill handling device 10 examines the bills 15 while moving the bills 15 among the cassettes 20. For example, when the bills 15 stored in the cassette 20B are examined, the control unit 70 controls the conveyance mechanism 60 to take out the bills 15 one by one from the cassette 20B. The control unit 70 then controls the conveyance mechanism 60 to convey the bills 15 that have been taken out to the determination unit 40 through the conveyance paths 61M, 61K, and 61I and the determination unit 40 determines the types of the bills 15. The control unit 70 then controls the conveyance mechanism 60 to convey the bills 15 whose types have been determined by the determination unit 40 to the cassette 20A through the conveyance paths 61B, 61C, and 61L.

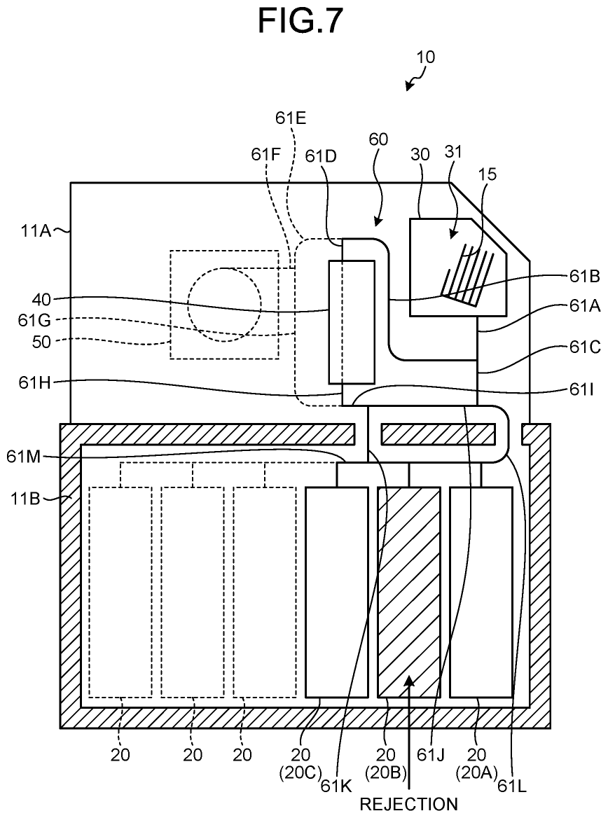

In addition, the bill handling device 10 may include a cassette for rejection that takes in the bills 15 unsuitable for recycling such as the bills 15 that are damaged and the bills 15 with a dirt. FIG. 7 is a view illustrating an example of a configuration of the bill handling device provided with a cassette for rejection. In FIG. 7, the three cassettes 20A to 20C are arranged side by side, and the second cassette 20B is the cassette for rejection. Note that the first cassette 20A may be the cassette for rejection.

Moreover, in the example of FIG. 7, the opening 21B is provided above a space between the cassette 20B which is the second from the one end and the cassette 20C which is the third from the one end. Through arranging of the cassette for rejection between the opening 21A and opening 21B, the bill handling device 10 can store the bills 15 that have been determined to be unsuitable for recycling by the determination unit 40 at time of dispensing in the cassette for rejection.

Note that in the bill handling device 10, the cassettes 20 indicated with broken lines may be added as cassettes for rejection. Through arranging of the cassettes 20 indicated with the broken lines, the bill handling device 10 can store the bills 15 that have been determined to be unsuitable for recycling by the determination unit 40 at time of depositing in the cassettes for rejection.

As described above, the bill handling device 10 of the embodiment includes the case 11A, the case 11B, and the conveyance mechanism 60. The case 11A is provided with the acceptance unit 30 and the determination unit 40. The acceptance unit 30 accepts the bills 15. The determination unit 40 determines the types of the bills 15 that are conveyed between the two conveyance ports 41A and 41B. In the case 11B, the bills 15 can pass from and to the case 11A through the openings 21A and 21B in two locations, and the plurality of cassettes 20 that can store the bills 15 can be arranged. The conveyance mechanism 60 is arranged inside the case 11A and the case 11B. Regarding at least one conveyance port of the two conveyance ports 41A and 41B of the determination unit 40, the conveyance mechanism 60 can convey the bills 15 to the openings 21A and 21B in two locations. The conveyance mechanism 60 can convey the bills 15 between the acceptance unit 30 and the plurality of cassettes 20 through the determination unit 40. The conveyance mechanism 60 can convey the bills 15 from any cassette of the plurality of cassettes 20 to other cassettes 20 through the determination unit 40. In this way, the bill handling device 10 can ensure high expandability.

Moreover, in the bill handling device 10 of the embodiment, the plurality of cassettes 20 can be arranged side by side in the case 11B. In the case 11B, the opening 21A, which is one of the openings 21A and 21B in two locations, is provided at one end of the plurality of cassettes 20, and the opening 21B, which is another one, is provided leaving a space corresponding to a width of one or two cassettes from the one end. The conveyance mechanism 60 has the conveyance path 61L between the opening 21A and the opening 21B, and the conveyance path 61M from the opening 21B to the other end side of the plurality of cassettes 20. In this way, when the number of the cassettes 20 is increased, the bill handling device 10 can arrange the cassettes 20 along the conveyance path 61M, whereby the number of the cassettes 20 can be increased with a little change in the conveyance path.

Moreover, in the bill handling device 10 of the embodiment, at time of examination of the bills 15 inside the plurality of cassettes 20, the conveyance mechanism 60 conveys the bills 15 from any of the cassettes 20 to the determination unit 40 using one of the conveyance path 61L and the conveyance path 61M. Moreover, the conveyance mechanism 60 conveys the bills 15 whose types have been determined by the determination unit 40 to the other cassettes 20 using another one of the conveyance path 61L and the conveyance path 61M. In this way, the bill handling device 10 can examine the bills 15 inside the plurality of cassettes 20.

Although the embodiment of the present invention has been described thus far, the present invention may be implemented in various different forms other than the embodiment described above.

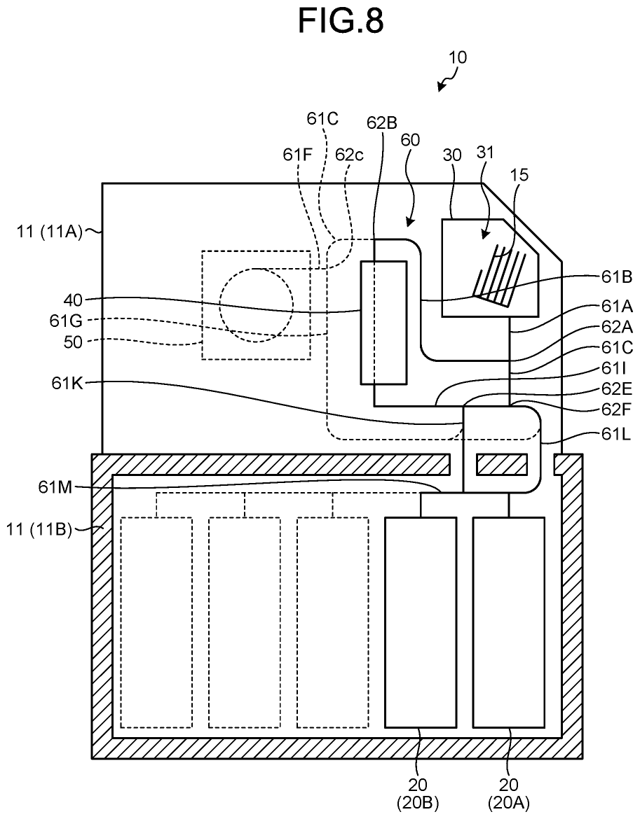

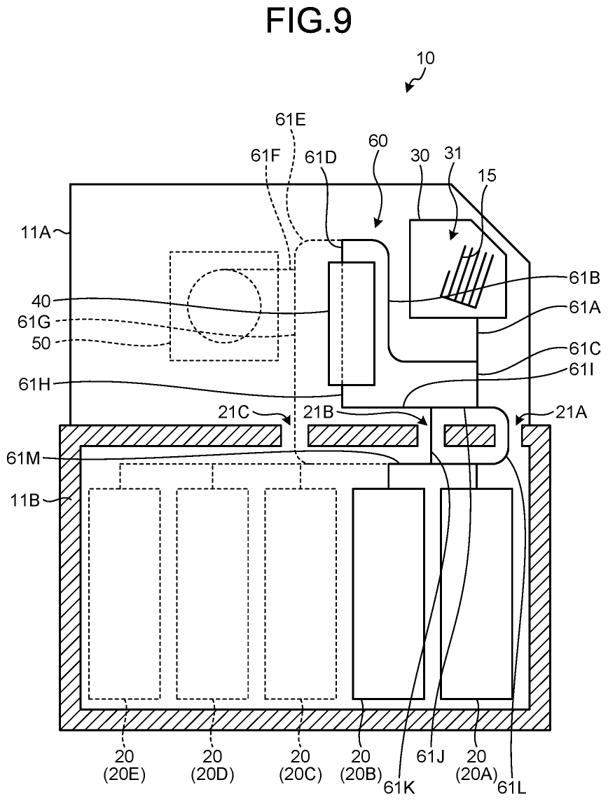

For example, the conveyance paths 61A to 61M of the conveyance mechanism 60 illustrated in FIG. 1 and the like are examples, and the present invention is not limited thereto. FIG. 8 is a view illustrating another example of a conveyance path of the bill handling device according to the embodiment. In the conveyance mechanism 60 illustrated in FIG. 8, the conveyance path 61I is connected with the conveyance port 41B of the determination unit 40. Moreover, in the conveyance mechanism 60 illustrated in FIG. 8, the conveyance path 61G may be branched from the conveyance path 61K or the conveyance path 61L. FIG. 9 is a view illustrating another example of a conveyance path of the bill handling device according to the embodiment. In the bill handling device 10 illustrated in FIG. 9, in addition to the openings 21A and 21B, an opening 21C is formed in the case 11B, and the bills 15 can pass between the case 11A and the case 11B through the openings 21A, 21B, and 21C. In the conveyance mechanism 60 illustrated in FIG. 9, the conveyance path 61I is connected with the conveyance port 41B of the determination unit 40. Moreover, in the conveyance mechanism 60 illustrated in FIG. 9, the conveyance path 61G may be branched from the conveyance path 61M through the opening 21C.

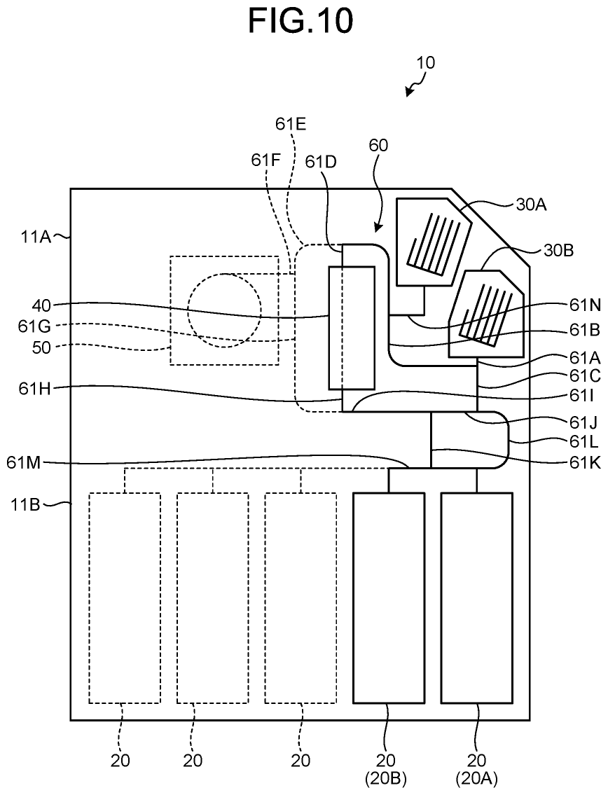

Moreover, the bill handling device 10 may be a type in which the acceptance unit 30 is separated for depositing and dispensing. FIG. 10 is a view illustrating another example of a configuration of the bill handling device according to the embodiment. The bill handling device 10 illustrated in FIG. 10 is provided with an acceptance unit 30A for depositing and an acceptance unit 30B for dispensing. The conveyance path 61A is connected with the acceptance unit 30B for dispensing. A conveyance path 61N branched from the conveyance path 61B is connected with the acceptance unit 30A for depositing. In this way, the bill handling device 10 may be a type in which the acceptance unit 30 is separated for depositing and dispensing.

Moreover, although, in the above embodiment, a case in which the paper sheets are the bills 15 is described, the present invention is not limited thereto. For example, the paper sheets may be securities such as bills, checks, gift certificates, various securities, and stock certificates.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A paper sheet handling device comprising:
a first case provided with an acceptance unit that accepts paper sheets and a determination unit that determines types of paper sheets that are conveyed between two conveyance ports;
a second case in which paper sheets can pass from and to the first case through openings in two locations and a plurality of cassettes capable of storing paper sheets can be arranged; and
a conveyance mechanism that is arranged in the first case and the second case, can convey paper sheets to the openings in two locations regarding at least one conveyance port of the two conveyance ports of the determination unit, can convey paper sheets between the acceptance unit and the plurality of cassettes through the determination unit, and can convey paper sheets from any cassette of the plurality of cassettes to other cassettes through the determination unit.

2. The paper sheet handling device according to claim 1, wherein
in the second case, the plurality of cassettes can be arranged side by side, one opening of the openings in two locations is provided at one end of the plurality of cassettes, and another opening is provided leaving a space corresponding to a width of one or two cassettes from the one end, and
the conveyance mechanism has a first conveyance path between the one opening and the other opening, and a second conveyance path from the other opening to another end side of the plurality of cassettes.

3. The paper sheet handling device according to claim 2, wherein
at time of examination of paper sheets inside the plurality of cassettes, the conveyance mechanism conveys the paper sheets from any cassette of the plurality of cassettes to the determination unit using one of the first conveyance path and the second conveyance path, and conveys the paper sheets whose types have been determined by the determination unit to other cassettes using another one of the first conveyance path and the second conveyance path.
